(19) United States
(12) Patent Application Publication
(10) Pub. No.: US 2017/0032676 A1
(43) Pub. Date: Feb. 2, 2017

(54) SYSTEM FOR DETECTING PEDESTRIANS BY FUSING COLOR AND DEPTH INFORMATION

(71) Applicants: Maral MESMAKHOSROSHAHI, Oak Park, IL (US); Maziar LOGHMAN, Chicago, IL (US); Joohee KIM, Oak Brook, IL (US)

(72) Inventors: Maral MESMAKHOSROSHAHI, Oak Park, IL (US); Maziar LOGHMAN, Chicago, IL (US); Joohee KIM, Oak Brook, IL (US)

(73) Assignee: ILLINOIS INSTITUTE OF TECHNOLOGY, Chicago, IL (US)

(21) Appl. No.: 15/216,934

(22) Filed: Jul. 22, 2016

Related U.S. Application Data
(60) Provisional application No. 62/199,065, filed on Jul. 30, 2015.

(51) Int. Cl. G08G 1/16; G06T 7/00; H04N 13/02

(52) U.S. Cl. CPC G08G 1/166; H04N 13/0203; G06T 7/004; G06T 7/0081; H04N 2013/0081

(57) ABSTRACT

A region of interest (ROI) generation method for stereo-based pedestrian detection systems. A vertical gradient of a clustered depth map is used to find ground plane and variable-sized bounding boxes are extracted on a boundary of the ground plane as ROIs. The ROIs are then classified into pedestrian and non-pedestrian classes. Simulation results show the algorithm outperforms the existing monocular and stereo-based methods.

### CROSS REFERENCE TO RELATED APPLICATION

This application claims the benefit of U.S. Provisional Patent Application, Ser. No. 62/199,065, filed on 30 Jul. 2015. The co-pending Provisional Patent Application is hereby incorporated by reference herein in its entirety and is made a part hereof, including but not limited to those portions which specifically appear hereinafter.

### BACKGROUND OF THE INVENTION

This invention relates generally to advanced driver assistance systems and, more particularly, to a method of and apparatus for improved pedestrian detection using on-board cameras.

Due to the development of the advanced driver assistance systems, on-board pedestrian detection has become an important research area in recent years which has as one objective detecting and tracking static and moving pedestrians on the road and warning drivers about their location. Early pedestrian detection methods used monocular cameras for detecting pedestrians. Recently, several attempts have been made to employ stereo vision in order to improve the performance of pedestrian detection. Some of the stereo-based approaches use a disparity map to extract ROIs for pedestrian detection. In several stereo-based pedestrian detection systems, a dense or sparse depth map is used to extract information about the geometric features of the objects and generate ROIs. Depth layering and skeleton extraction have been used for ROI generation. There is a continuing need for improved pedestrian detection in driver assistance systems.

### SUMMARY OF THE INVENTION

The invention provides a method and apparatus for determining objects such as pedestrians in images taken by a stereo vision camera, such as in a driver assistance system. According to some embodiments of this invention, there is a stereo-based ROI generation algorithm for pedestrian detection by fusing the depth and color information obtained from a stereo vision camera to locate pedestrians in challenging urban scenarios by extracting the ground plane and generating variable-sized ROIs.

In some embodiments of this invention, the proposed pedestrian detection method and system fuses color and depth information extracted from a stereo vision camera to locate pedestrians on the road. One objective of this invention is to reduce the search space for pedestrian detection by finding the ground plane using depth information. Unlike the existing methods, some embodiments of this invention use the vertical gradient of the depth map to find the ground plane to reduce the search space and improve the processing time and accuracy of the system. Also, according to some embodiments of this invention there is proposed a new method for detecting pedestrians at different sizes and distances. In the method according to some embodiments of this invention, depth information is used to estimate the size of the pedestrians and extract variable sized ROIs. Therefore, the invention does not need to use existing multi resolution methods to find pedestrians at different scales. The extracted ROIs can be classified using HOG/SVM, which is one of the existing state of the art methods. To improve the processing speed of the system, in some embodiments of this invention there is a new ROI reduction method by taking advantage of the temporal correlation between the image sequences. In the method according to some embodiments of this invention, the classification scores obtained from the previous frames are used to estimate the score of ROIs and discard hard negatives without computing feature vectors.

### BRIEF DESCRIPTION OF THE DRAWINGS

FIG. 1 is a block diagram of steps used in the pedestrian detection method according to one embodiment of this invention.

FIG. 2 shows depth and gradient values plotted for (a) a frame of an original image with columns, with (b) a depth frame, (c) a quantized depth map, (d) depth values for the left column and (e) their gradients, and (f) depth values for the right column and (g) their gradients (right).

FIG. 3 shows (a) ground plane extracted from a grey scale frame, and (b) boundary of the ground plane which is used to search for pedestrians (path).

FIG. 4 illustrates a pedestrian at different distances from the camera.

FIG. 5 shows a performance comparison between the method according to some embodiments of this invention and the other methods.

### DESCRIPTION OF THE INVENTION

The invention includes a method and/or a system for determining objects, such as pedestrians, in images taken by a stereo vision camera, such as in a driver assistance system. The invention uses depth and/or color information obtained from the camera to locate objects. The invention reduces the search space for pedestrian detection by finding ground plane using depth information and performing pedestrian detection on the boundary of the ground plane. The reduction in search space results in faster processing and improved pedestrian detection or analysis.

In some embodiments of the stereo-based ROI generation framework, first a depth map is clustered using uniform quantization and ground plane is extracted using the vertical gradient of the clustered depth map. The boundary of the ground plane is then considered as an area where pedestrians can stand and variable-sized bounding boxes are used to search for pedestrians and generate the candidate regions for pedestrian detection.

In some embodiments of this invention, methods are proposed for ground plane extraction using stereo cameras. Conventional methods based on monocular cameras are not robust against illumination variations and exhaustive search based methods incur huge computational complexity. The invention includes a fast ground plane extraction method which uses depth information and is robust against illumination variations.

The depth data obtained from the stereo images captured by a stereo camera, for example, installed in a vehicle provides the perspective view of a scene in which the distance from the camera changes in a vertical direction. Therefore, in a depth image, the depth values of the ground plane decrease in the vertical direction from the nearest to the farthest part of the regions. In some embodiments of the method according to this invention, a depth map is first quantized and several depth layers are generated in order to cluster the objects based on their distance from the camera and take the vertical gradient of the clustered depth map in order to estimate the ground plane.

The vertical gradient of the depth image can be computed using the Sobel gradient operator of Equation 1, as discussed in, for example, N. Dalal et al., “Histograms of Oriented Gradients for Human Detection,” In Proc. of the Computer Vision and Pattern Recognition (CVPR), vol. 1, pp. 886-893, June 2005, herein incorporated by reference.

$${∇}_{y} d = [ \begin{matrix}- 1 & 0 & 1 \\ - 2 & 0 & 2 \\ - 1 & 0 & 1\end{matrix} ] * d , \qquad ( 1 )$$

where d and ∇_{y}d are the depth image and its vertical gradient, respectively and * denotes the 2-D convolution. In order to extract the ground plane in the image, the gradient values and the distance between the two consecutive nonzero gradient values are thresholded using Tᵥₐₗ and T_{dist}, respectively.

In many conventional pedestrian detection methods, fixed-sized windows and exhaustive scanning are used to search for pedestrians in the entire image which incur huge computational complexity. Fixed-sized ROIs are unable to detect pedestrians with different sizes as well. In order to overcome these limitations, in some embodiments of this invention a stereo-based ROI generation method is used for pedestrian detection. In some embodiments, the method uses and finds the boundary of the ground plane extracted as an area where a pedestrian can stand. To extract the regions of interest, the method uses the depth values of the boundary pixels to estimate the size of the pedestrians. Since the size of the object in pixel is proportional to the disparity value, we can estimate the height and width of the bounding box using Equation (2):

$$[ \begin{matrix}h \\ w\end{matrix} ] = \frac{{d}_{b}}{255} \times [ \begin{matrix}{h}_{1} \\ {w}_{1}\end{matrix} ] , \qquad ( 2 )$$

where the initial bounding box size is wₗ×hₗ and d_{b} is the disparity value of the pixel on the boundary. To ensure that pedestrians with different poses are detected, more than one, and desirably three, bounding box are used for each boundary pixel (i,j) where the location of the top-left corners are (i−h,j−w/2), (i−h,j) and (i−h,j+w/2). Then, the method thresholds the area of the foreground object inside the window in order to extract the ROIs.

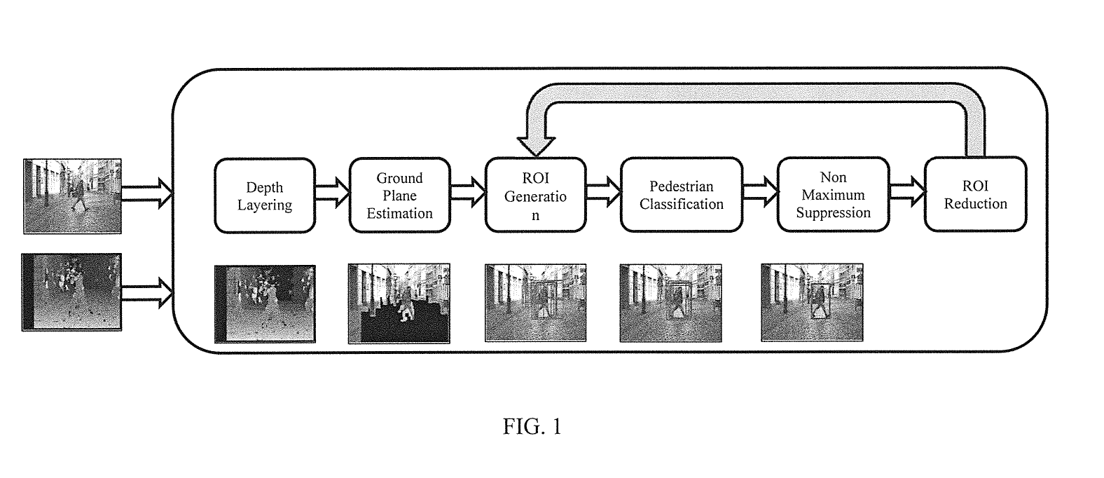

FIG. 1 shows a block diagram of steps in the pedestrian detection system according to some embodiments of this invention. In most of the existing pedestrian detection systems, the whole frame is used to search for pedestrians. To reduce the search space, the ground plane is first found using the vertical gradient of the depth map. Then pedestrians are searched on the boundary of the ground plane. Unlike the existing methods which perform pedestrian detection on different image resolutions, the size of the pedestrians is estimated based on their distance from the camera using depth information to make the pedestrian detection system scale invariant. Variable sized ROIs are extracted from the color image and a classification system is used to classify the ROIs into the pedestrian and non-pedestrian classes. To reduce the number of ROIs and improve the processing speed, the method takes advantage of temporal correlation between the image sequences. In existing methods, temporal correlation is used for object tracking applications. In the method of this invention, the classification scores can be obtained from the previous frames to discard hard negatives.

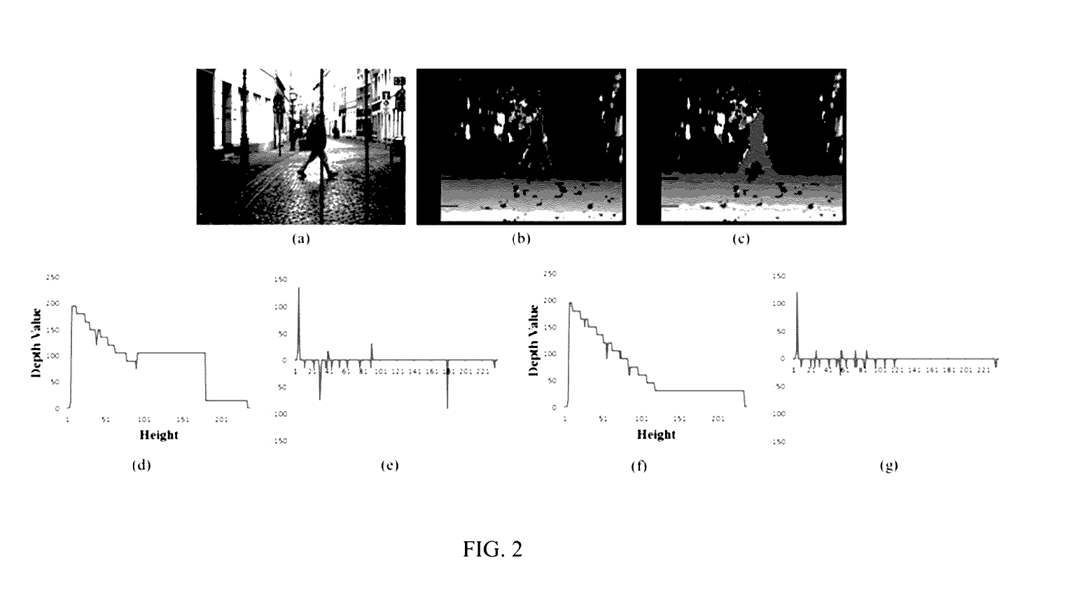

In driver assistance systems, the camera is mounted on the vehicle and provides a perspective view of the street. As can be seen in FIG. 2, in flat regions such as road areas and pavements, the distance from the camera is changing in the vertical direction. In depth frames, depth values of these regions decrease in the vertical direction from the nearest part to the farthest part of these regions. In other words, for each column in the image, a depth value is monotonically decreasing from the bottom to the top of the image. In embodiments of this invention, the method quantizes the depth map and takes the gradient of the quantized depth in the vertical direction using Equation (1), where d(i, j) and ∇_{y}d(i,j) are depth value and gradient of the pixel located at (i, j), respectively. FIGS. 2 (d) to (g) show depth and gradient values plotted for two different columns marked as lines in FIG. 2 (a).

To successfully estimate the ground plane, in some embodiments of this invention, the method first thresholds the depth gradient values and keep regions with depth gradients less than a certain value (Tᵥₐₗ). Then, if the distance between two corresponding selected gradient values is less than a predefined threshold (T_{dist}), the area between these locations will be considered as ground plane and other regions will be discarded. Since the depth maps are usually noisy, the results can be refined using morphological operations.

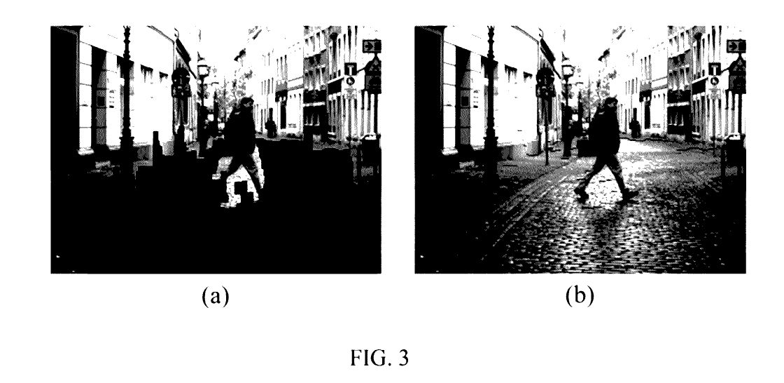

To reduce the search space, according to some embodiments of this invention, possible pedestrian regions are first extracted as regions of interest (ROI). The method includes an ROI generation method for pedestrian detection using variable sized bounding boxes. Assuming that pedestrians are standing on ground plane, the boundary of the ground plane can be extracted as an area where a pedestrian can possibly stand. FIG. 3 shows an example of candidate regions where a pedestrian can exist.

The pedestrian detection method and system of this invention can be used as one of the main modules of an advanced driver assistance systems (ADAS) and intelligent vehicles. ADAS systems aim at increasing the road safety by assisting the drivers and reducing the accidents caused by human error. ADAS systems have several modules for different tasks such as traffic monitoring, driver's state monitoring, communications and reasoning, etc. The traffic monitoring module in ADAS systems is responsible for pedestrian and vehicle detection, road detection and lane estimation and traffic sign recognition. Pedestrian detection is one of the main goals in ADAS systems which aims at detecting and tracking static and moving pedestrians on the road and warn the driver about their location and state.

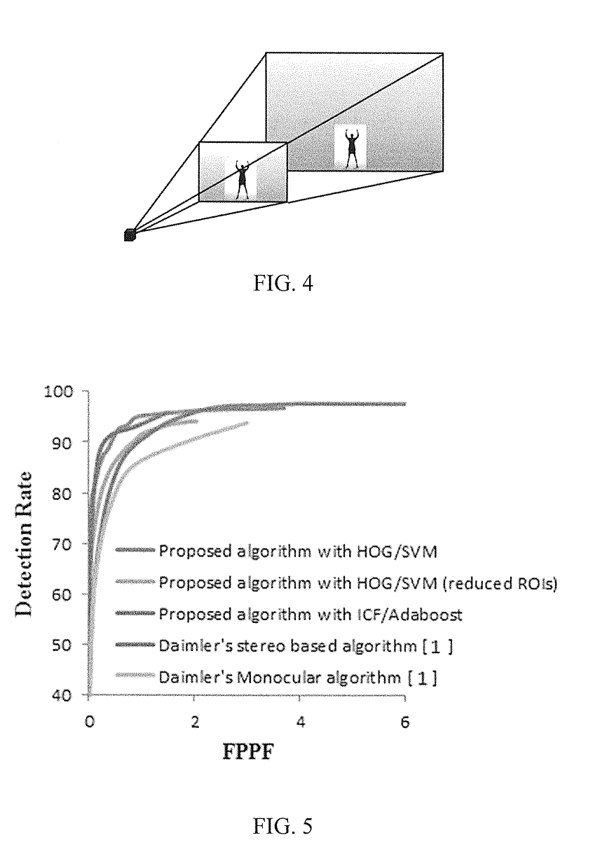

In ADAS systems, the size of the pedestrian changes frame by frame because of the movement of the camera. FIG. 4 shows a pedestrian in different distances from the camera. Since the perceived size of an object is most strongly influenced by the object's distance from the camera, the detection window size for ROI search is determined in each sub-image based on the depth value. Therefore, rectangular bounding boxes are first defined with a height and width calculated for each pixel using Equation (2), where hₗ and wₗ are the initial size of the pedestrian and d_{b} is the depth value of the pixel on the boundary. Then, the number of pixels with the depth value d_{b} inside the bounding box is counted and if it is greater than ¼ of the area of the bounding box, the region is considered as an ROI, otherwise it is ignored. Extracted ROIs can then be classified with the HOG/Linear SVM classification method.

To achieve a higher processing speed, in some embodiments of this invention, the method takes advantage of temporal correlation between image sequences to reduce the number of ROIs before extracting feature vector. Because of the similarity between the image sequences, the location of road boundary and thus the location and size of the ROIs in the current frame do not have a significant change compared with the previous frame. Therefore, if the classifier classifies all of the ROIs in a neighborhood of the previous frame as hard negative, it can be expected that the ROIs in the corresponding neighborhood of the current frame are hard negative as well.

In some embodiments of this invention, one objective is to estimate the classification score of the classifier for the ROIs in the current frame using the scores calculated for the previous frames and discard hard negatives. To do this, the method first defines a 21×21 neighborhood for each ROI in the current frame and previous frames. To be able to recover false negatives, the scores from 5 previous frames are used instead of only one frame. The estimated score of each pixel in the neighborhood is computed as the mean of the classification scores of the corresponding locations in the previous frames using Equation (3):

$${ES}_{k} ( i , j ) = \frac{1}{5} {\sum }_{t = k - 5}^{k - 1} {cs}_{t} ( i , j ) , \qquad ( 3 )$$

where csₜ(i, j)s are classification scores of the ROIs in the previous frames and ESₖ(i, j)s are the estimated scores of the ROIs in the neighborhood of the current frame k. Then, the positive estimated scores in the ES are counted and if greater than a threshold, the method extracts the feature for the ROI. Otherwise, it will be classified as a negative. To reduce false negatives, in some embodiments of this invention, the extraction of features and classification all of the ROIs every 5 frames with the actual classification scores can be used.

By counting the positive values in the estimated score, the classification score of the ROIs that do not have any pedestrian in their neighborhood will be negative and can be discarded without extracting their feature vector. This step can reduce the number of ROIs and computational complexity as well.

In some embodiments of this invention, one benefit of the invention compared to the existing systems is that unlike the traditional methods which use an exhaustive search on every pixel to look for pedestrians, the invention reduces the search space by limiting the search on the boundary of the ground plane estimated using the depth map. Also, instead of using traditional fixed sized bounding boxes and multi resolution methods, the invention calculates the size of the pedestrians at each pixel using their distance information extracted from the depth map. Using this method can improve the accuracy and speed of the system compared to the existing methods.

In some embodiments of this invention, the system is dependent on the quality of depth maps which can impact the accuracy in poor lighting conditions such as rainy weathers and when the quality of image is not good enough.

The present invention is described in further detail in connection with the following examples which illustrate or simulate various aspects involved in the practice of the invention. It is to be understood that all changes that come within the spirit of the invention are desired to be protected and thus the invention is not to be construed as limited by these examples.

To evaluate the performance of the method according to some embodiments of this invention, the Daimler pedestrian benchmark was used (C. G. Keller et al., “A New Benchmark for Stereo-based Pedestrian Detection,” In Proc. of the Intelligent Vehicles Symposium (IVS), pp. 691-696, June 2011). The Daimler dataset contained 640×480 stereo image pairs captured with a stereo vision camera from a moving vehicle. In our experiments, stereo images were downsampled to reduce the computational complexity.

Among several stereo matching algorithms, the block matching method was used for depth estimation by setting the block size and the maximum disparity to 10×10 and 32, respectively. In experiments, images were downsampled to 320×240 and the quantization levels is set to 15 and the threshold values, Tᵥₐₗ and T_{dist} were set to 60 and 30, respectively. Also, the initial window size was set to 125×250.

The performance of the ROI generation algorithm was tested by computing the average number of ROIs per frame. The detection rate and the processing time of each step for the 21790 frames in the test set which are shown in Table I and II. The results show that the probability of missing pedestrians in the method according to embodiments of this invention is very low, while reducing the computational complexity significantly compared to the exhaustive search.

ROIs were classified using the HOG/Linear SVM (N. Dalal et al.) and ICF/Adaboost (P. Dollar et al., “Integral channel features,” In Proc. of the British Machine Vision Conf (BMVC), 2009). FIG. 5 shows the ROC curves that compare the performance of the pedestrian detection system of this invention and the pedestrian detection methods introduced in C. G. Keller et al. Simulation results show that the method according to some embodiments of this invention outperforms the Daimler's monocular pedestrian detection method and provides competitive results with their stereo-based method.

TABLE I
PERFORMANCE OF THE PROPOSED ROI GENERATION

| Method | Detection rate | #ROIs |
|---|---|---|
| Proposed ROI generation | 98.8% | 630 |

TABLE II
PROCESSING TIME FOR THE ROI GENERATION STEPS

| Step | Proc. Time (ms) |
|---|---|
| Ground plane estimation | 2.71 |
| ROI generation | 20.8 |

Table III shows the performance and the average number of ROIs per frame for another performance evaluation testing the accuracy of the ROI generation algorithm on a Daimler dataset.

TABLE III
PERFORMANCE OF THE PROPOSED ROI GENERATION

| Method | Detection rate | #ROIs/frame |
|---|---|---|
| Proposed alg. | 98.8% | 500 |

Again, the performance of the pedestrian detector was tested using HOG/SVM and ICF/Adaboost pedestrian classification methods. Table IV shows the performance of the ROI generation of this invention classified with HOG/SVM and ICF/Adaboost compared with the monocular and stereo based pedestrian detection methods.

TABLE IV
PERFORMANCE COMPARISON OF THE METHOD

| Method | Detection rate |
|---|---|
| Proposed alg. with HOG/SVM | 95% |
| Proposed alg. with ICF/Adaboost | 91% |
| Daimlers Stereo alg. | 94% |
| Daimler's mono alg. | 86% |

Simulation results show that certain embodiments of this invention of our proposed method outperforms the Daimler's monocular and stereo based pedestrian detection methods.

Thus, the invention provides a method of improving pedestrian detection in images such as provided by vehicle cameras. The method can be implemented by the processor and stored as executable software instructions on a recordable medium of existing or new camera systems. The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A method of determining pedestrians in images taken by a stereo vision camera of a driver assistance system, the method comprising:
fusing depth and color information obtained from the camera to locate pedestrians.

2. The method of claim 1, further comprising reducing search space for pedestrian detection by finding ground plane from the images using depth information.

3. The method of claim 1, further comprising extracting ground plane from the images and generating variable-sized region of interests.

4. The method of claim 1, further comprising estimating a size of the pedestrians using depth information obtained from the stereo images.

5. The method of claim 4, further comprising calculating a size of the pedestrians on pixel by pixel basis using distance information extracted from the depth information.

6. The method of claim 1, further comprising:
clustering a depth map using uniform quantization;
extracting ground plane using a vertical gradient of the clustered depth map.

7. The method of claim 6, further comprising:
identifying a boundary of the ground plane; and
searching for pedestrians at the boundary using a plurality of variable-sized bounding boxes.

8. The method of claim 7, further comprising estimating a size of the pedestrians using depth values of boundary pixels.

9. The method of claim 6, further comprising:
generating several depth layers in the depth map;
clustering objects based upon a corresponding distance from the camera; and
estimating ground plane using a vertical gradient of the clustered depth map.

10. The method of claim 9, further comprising:
identifying a boundary of the ground plane; and
searching for pedestrians at the boundary using a plurality of variable-sized bounding boxes.

11. The method of claim 10, further comprising estimating a size of the pedestrians using depth values of boundary pixels.

12. The method of claim 11, further comprising extracting more than one bounding box for each of the boundary pixels.
